(19) United States
(12) Patent Application Publication
(10) Pub. No.: US 2025/0214876 A1
(43) Pub. Date: Jul. 3, 2025

(54) WATER TREATMENT USING MICROBUBBLES AND NANOBUBBLES

(71) Applicant: Kohler Co., Kohler, WI (US)

(72) Inventor: Jason M. Kwacz, Kohler, WI (US)

(21) Appl. No.: 18/975,432

(22) Filed: Dec. 10, 2024

Related U.S. Application Data
(60) Provisional application No. 63/616,861, filed on Jan. 2, 2024.

(51) Int. Cl. C02F 1/74; C02F 103/02; E03D 9/00; E03D 9/08

(52) U.S. Cl. CPC C02F 1/74; E03D 9/002; E03D 9/08; C02F 2103/02; C02F 2303/26; C02F 2307/06

(57) ABSTRACT

A toilet includes a tank and a bowl. A bubble generation device including a nozzle is configured to release nanobubbles to the tank or the bowl. A controller is configured to generate a command for the bubble generation device to release nanobubbles from the nozzle into the tank and/or the bowl.

### CROSS REFERENCE TO RELATED APPLICATION

This application claims the benefit of priority to U.S. Provisional Application No. 63/616,861 filed on Jan. 2, 2024, which is hereby incorporated by reference in its entirety.

### FIELD

The present application relates generally to the application of microbubbles and nanobubbles in water-consuming appliances and plumbing fixtures.

### BACKGROUND

Microbubbles and nanobubbles are microscopic gas entities having similar form and differing in size. Microbubbles and nanobubbles have capacity in disinfection and sterilization processes. As attention and concerns are increasingly placed toward the risks of bacterial contamination and corresponding infection, microbubbles and nanobubbles may play an increasing role in water safety and water treatment.

### BRIEF DESCRIPTION OF THE DRAWINGS

Exemplary embodiments are described herein with reference to the following drawings, according to an exemplary embodiment.

FIG. 1 illustrates an example toilet for use with a bubble generation device.

FIG. 2 illustrates an example bubble generation device for the toilet of FIG. 1.

FIG. 3 illustrates an example faucet for use with a bubble generation system.

FIG. 4 illustrates example kitchen appliances for use with a bubble disinfection system.

FIG. 5 illustrates example shower appliances for use with a bubble generation system.

FIG. 6 illustrates an example handshower for use with a bubble generation system.

FIG. 7 illustrates an example bathtub for use with a bubble generation system.

FIG. 8 illustrates an example bidet for use with a bubble generation system.

FIG. 9 illustrates an example bubble generation system.

FIG. 10 illustrates another example bubble generation system.

FIG. 11 illustrates an example bubble generation system.

FIG. 12 illustrates a distribution system for the generated bubbles.

FIG. 13 illustrates an example controller for any of the bubble generation systems.

FIG. 14 illustrates an example flow chart for the controller of FIG. 13.

### DETAILED DESCRIPTION

The following embodiments include applications of microbubbles and nanobubbles (MNBs) in water consuming devices and plumbing fixtures. A single bubble generation process may produce both microbubbles and nanobubbles in varying proportions. The term nanobubbles may be used to describe bubbles having a diameter of up to approximately 1 micrometer (μm). The term microbubbles may be used to describe bubbles with diameters that are approximately from 1 to 100 μm. Additional bubbles may be present when MNBs are generated such as bubbles with diameters from 100 to 1000 μm or larger. Microbubbles are visible to the human eye. Nanobubbles are not visible to the unaided human eye. Microbubbles may have a lifetime duration before implosion in water. In one example, the lifetime duration may be at least 1 minute. In some examples, the lifetime duration is in the range of about 2 to 4 minutes. In some systems, nanobubbles may have a lifetime duration before implosion in water that is less than that of microbubbles (e.g., a few to hundreds of milliseconds), but in some examples, nanobubbles may have a lifetime duration before implosion in water that is much longer than that of microbubbles (e.g., hours, days, or weeks). The term MNBs may include a mixture of microbubbles and nanobubbles such that the proportion of nanobubbles is statistically significant. In some examples, the proportion of nanobubbles is a majority by quantity of bubbles in the MNBs. The term “majority” may mean more than 50% by quantity. In another example, the statistically significant may refer to a predetermined number of standard deviations of the average diameters of the MNBs. For example, at least one standard deviation from the mean of the diameters MNBs may be less than one micrometer.

Some generation processes may be directed at nanobubbles primarily while others may be directed at microbubbles primarily. Some generation processes may produce bubbles of ozone (trioxide or O₃) hydrogen gas, carbon dioxide gas, or bubbles of air, which may include various constituents or molecules such as nitrogen, oxygen, argon, carbon dioxide and other gases. Ozonated water is a powerful disinfectant that can be generated on-site at a particular device. On-site generation has advantages. One advantage is that there are no consumable chemicals required. One problem is that ozone has a slow and limited solubility in water. As such, ozone gas likely escapes from the water surface and into the environment.

A variety of techniques may be used to produce MNBs. In one example, an air stream under pressure is dissolved into liquid with a nozzle to generate bubbles under the cavitation principle. The nozzle may be a venturi tube. In cavitation the static pressure of a liquid is below the liquid's vapor pressure, causing vapor filled cavities to form. The vapor pressure is the pressured in thermodynamic equilibrium with the other phases (liquid and solid) at a specific temperature. In another example, MNBs are formed from ultrasound to induce cavitation in the liquid. In another example, MNBs are formed through a shearing force. The air stream is provided under low pressure and bubbles are broken off into the liquid using the shearing force. The shearing force may be a vibration, provided from fluidic oscillation, or other methods.

MNBs may provide a variety of benefits in a variety of applications. Some benefits may be considered water treatments. Some benefits may improve the feel, texture, and appearance of the water. Water with MNBs may feel silky to the touch and may increase moisture level when in contact with the human body such as skin and hear. In addition, MNBs may enhance the surface cleaning, dirt removal, oil removal, and cosmetics removal abilities of the water. Water with MNBs may aid in removal of scale buildup on surfaces.

In some examples, the MNBs experience cavitation, resulting in an implosion of the bubbles to release hydroxyl radicals and causing physiochemical transformations in the water. In some examples, the MNBs have an electrostatic charge on or associated with the surface of the bubble such that the presence of the bubble treats or otherwise affects the water before the MNBs ultimately implode. The electrostatic charge on the MNBs may be negative.

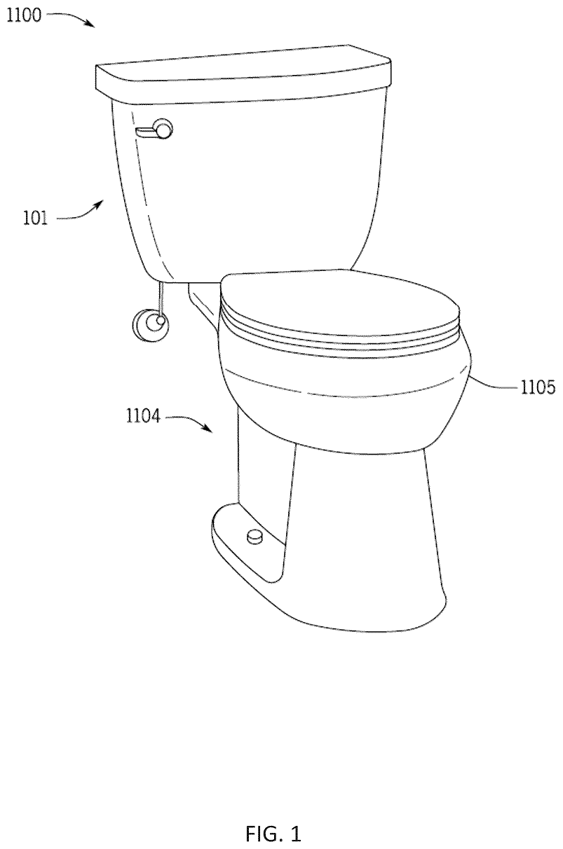

FIG. 1 illustrates an example toilet for use with a bubble generation system. Referring to FIG. 1, a toilet 1100 with the bubble generation system is illustrated according to an exemplary embodiment of the present disclosure. The toilet 1100 may include a tank (e.g., container, reservoir, etc.), shown as a tank 101, and a pedestal (e.g., base, stand, support, etc.), shown as a pedestal 1104. The tank 101 may be coupled to, and supported by, the pedestal 1104, which may be positioned on a floor. In some embodiments, the tank 101 and the pedestal 1104 may be formed together as a single component. In some other examples, the tank 101 may be mounted nearby on a wall, or within a wall. The tank 101 is configured to receive water (e.g., via a fill valve of the toilet 1100, etc.) and store the water in between flushes. The pedestal 1104 includes a bowl 1105 and may be configured to receive the water from the tank 101 to flush contents of bowl into a sewage line. In some embodiments, the pedestal 1104 may be mounted on the wall of a lavatory and the bowl may be configured to receive water from a fluid supply source such as a household water supply.

The bowl 1105 of the pedestal 1104 includes a sump (e.g. a receptacle) and an outlet opening, wherein water and waste is collected in the sump until being removed through the outlet opening, such as when the contents of the bowl 1105 are flushed into a sewage line. The toilet 1100 further includes a trapway, and the trapway may be fluidly connected to the bowl 1105 via the sump. The trapway fluidly connects the sump to the outlet opening.

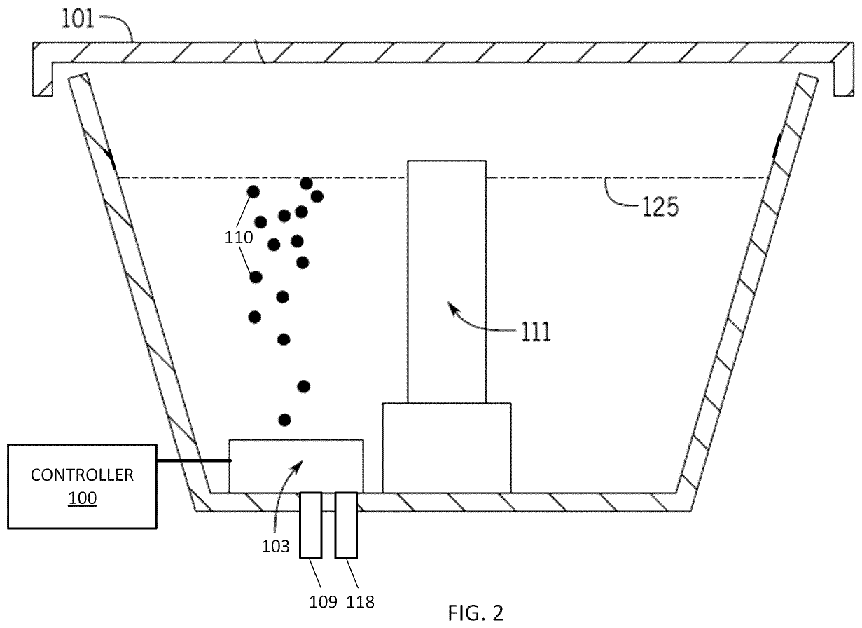

FIG. 2 illustrates an example tank 101 including bubble generation device 103. The bubble generation device 103 may include at least one electrical input (e.g., electrical connection 118) to a power source and at least one air input (e.g., hose 109) to an air source (e.g., a pump). The bubble generation device 103 may receive commands from a controller 100. The controller 100 may instruct the bubble generation device 103 when to start generating bubbles 110 (e.g., initiation command) and when to stop generating bubbles 110 (e.g., stop command). The command from the controller 100 may include a size or a size range from the bubble generation device 103. The bubble generation device 103 may adjust a parameter of the bubble generation process. In one example, the parameter is a magnitude of the shearing force for bubble generation. In one example, the parameter is a flow of an air stream for generating MNBs. In one example, the parameter may be a magnitude of a vibration or fluid oscillation.

Bubbles 110 released from the bubble generation device 103 treat the water 125 in the tank 101. A flush valve 111 selectively provides the water 125 to the bowl 1105 of the toilet. Additional, different, or fewer components may be included.

The bubbles 110 may be applied to the inside of the bowl 1105 when the water 125 is released from the tank 101 by the flush valve 111. The bubbles 110 may dislodge particles from the bowl 1105 or the tank 101 (e.g., in cavities in the vitreous material that the bowl 1105 or tank 101 is formed from). The bubbles 110 may disinfect tank 101 and/or the bowl 1105. The bubbles 110 may kill gems. The bubbles 110 may reduce the scale build up in the bowl 1105 and the tank 101.

Ozone may be formed by the bubble generation device 103 using a variety of techniques, including corona discharge, ultraviolet light, cold plasma, and other techniques. For example, a corona charger may be configured to accumulate electric charge from the power source and apply the electric charge to air from the air source.

The controller 100 may send commands to the bubble generation device 103. For example, the commands may initiate the generation of bubbles 110. The commands may be triggered by a time schedule (e.g., once every predetermined time period or at certain times of day). The commands may be triggered by a flush cycle. That is, the controller 100 may send a command to the bubble generation device 103 to generate bubbles 110 when the tank 101 is filled.

The controller 100 may send a command to the bubble generation device 103 to generate bubbles 110 in response to a user input. For example, a flush cycle may be initiated by operation of an actuator. The actuator may be a button configured to initiate the flush cycle when depressed (or pulled) a predetermined distance or when touched, a lever configured to activate when rotated a predetermined angular travel, or any suitable device configured to activate based on an input manipulation by a user. In some embodiments, the actuator may be a sensor (e.g., a proximity sensor) and the flush cycle may be automatically initiated (e.g., by a controller) based on sensor data received from the sensor. The controller 100 may also receive sensor data as feedback for one or more conditions in proximity to the tank 101 or the toilet.

In the instance of automatic initiation of the flush cycle, the controller 100, may receive sensor data indicative of usage of the toilet. For example, the controller 100 may be in communication with a sensor configured to detect the presence of a user and initiate the flush cycle in response to a user leaving the vicinity of the toilet.

The sensor may include any type of sensor configured to detect certain actions and/or to provide functionality (e.g., dispensing, flushing, etc.). The sensor may include any type of sensor configured to detect certain conditions and/or to provide functionality. Odor sensors, proximity sensors, and motion sensors are non-limiting examples of sensors that may be employed with the systems of this application. Odor sensors, such as volatile organic compound (VOC) sensors, may be employed to detect organic chemicals and compounds, both human made and naturally occurring chemicals/compounds. Proximity sensors may be employed to detect the presence of an object within a zone of detection without physical contact between the object and the sensor. Electric potential sensors, capacitance sensors, projected capacitance sensors, and infrared sensors (e.g., projected infrared sensors, passive infrared sensors) are non-limiting examples of proximity sensors that may be employed with the systems of this application. Motion sensors may be employed to detect motion (e.g., a change in position of an object relative to the objects surroundings). Electric potential sensors, optic sensors, radio-frequency (RF) sensors, sound sensors, magnetic sensors (e.g., magnetometers), vibration sensors, and infrared sensors (e.g., projected infrared sensors, passive infrared sensors) are non-limiting examples of motion sensors that may be employed with the systems of this application.

In another example, the sensor may include a sensor configured to detect a water level of water 125. The sensor may include a float sensor, a pressure level sensor, an ultrasonic water level transmitter, a capacitance level sensor (e.g., an RF sensor), and a radar level sensor. Further, an optical sensor may be used to determine a water level. The bubble generation device 103 may be activated by the controller 100 when the sensor indicates that the predetermined water level has been reached.

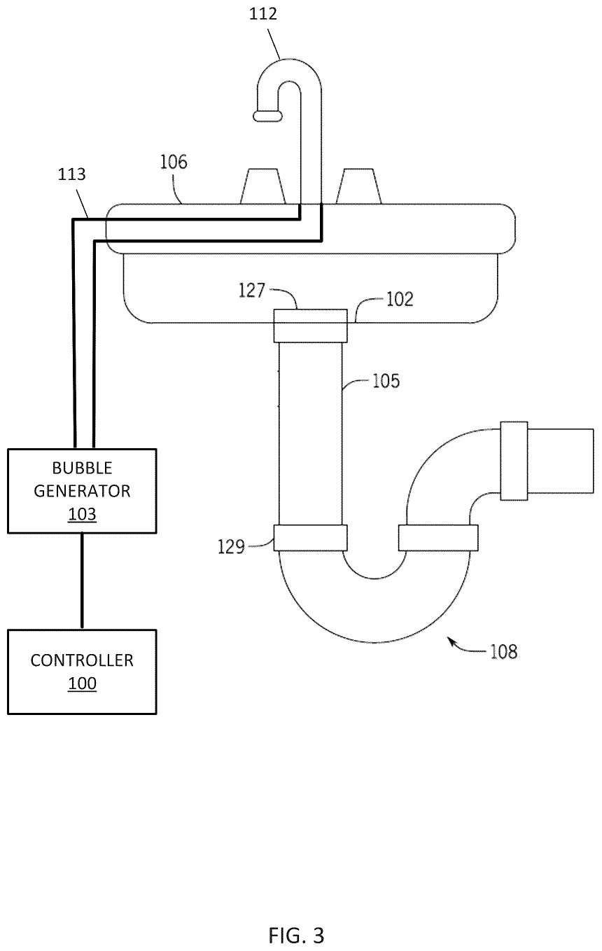

FIG. 3 illustrates an example faucet 112 for use with a bubble disinfection system (e.g., bubble generation device 103) on a lavatory or sink 106. The sink 106 may be connected to a first plumbing system (e.g., including hose or pipe 113) connected to the bubble generation device 103 and a second plumbing system 108 for draining the sink 106. The second plumbing system may include a tailpipe 105 extending from the drain 102 and one or more valves 127 and 129. Additional, fewer or different components may be included.

The first plumbing system is illustrated as a single pipe 113 but may include at least one water passage or pipe for hot water and at least one water passage or pipe for cold water. In addition, at least one water passage or pipe may bypass the bubble generation device 103. Thus, in one example, four pipes are used: a hot water pipe including bubbles from the bubble generation device 103, a cold water pipe including bubbles from the bubble generation device 103, a hot water pipe that bypasses the bubble generation device 103, and a cold water pipe that bypasses the bubble generation device 103. In some examples, the bubble generation device 103 is included only on the hot water lines.

The controller 100 is configured to activate and deactivate the bubble generation device 103. The controller 100 is configured to activate and deactivate valves for bypassing the bubble generation device 103.

The bubble generation device 103 generates MNBs or bubbles 110 into the pipe 113 to travel through the faucet 112. In some examples, the bubbles 110 are used for enhancing the cleaning process of water dispensed from the faucet 112. The bubbles 110 improve cleaning of fruits and vegetables and may remove pesticide on fruits and vegetables. The bubbles 110 improve the efficiency of hot water killing germs (e.g., on the user's hands, etc.). The bubbles 110 may improve pore cleaning and exfoliation.

The user may close (e.g., place a cap on) the drain 102 to collect water and bubbles 110 in the basin. Fruits, vegetables, hands, or other items may be placed in the collected water to realize the benefits of the bubbles 110. Similarly, the plumbing system 108 may include a valve for closing off the tail pipe 105 or the P-trap during a cleaning process using the bubbles 110. The valve 129 may include a mechanical knob or lever for operation of the valve 129. The valve 129 may include a motor or solenoid operated by a controller (e.g., controller 100 described herein). The controller 100 may close the valve 129 in response to operation of the controller 100 or the user input to start the bubble generation device 103.

The controller 100 may send commands to the bubble generation device 103. For example, the commands may initiate the generation of bubbles 110. The commands may be triggered by a time schedule (e.g., once every predetermined time period or at certain times of day). The commands may be triggered by operation of the faucet 112. In other examples, the user may provide a separate bubble generation input, which may be a button on the faucet 112, a gesture detected by the faucet 112, a voice command, or another input. In some embodiments, a proximity sensor initiates operation of the bubble generation device 103 when the user approaches the sink 106.

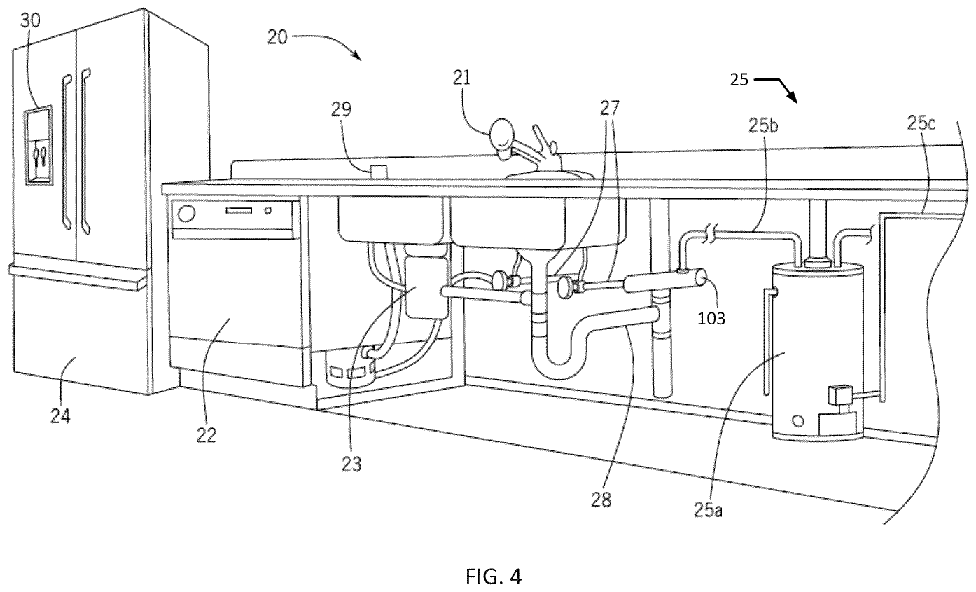

FIG. 4 illustrates example kitchen appliances for use with a bubble disinfection system (e.g., bubble generation device 103) that is placed in-line with the plumbing system. The kitchen devices may include one or more of a kitchen faucet 21, a dishwasher 22, a garbage disposal 23, a refrigerator 24, a water heater 25, and a water filter. Each of the intelligent kitchen devices may be connected to a water supply 27 and a drain 28. The water supply may include the bubble generation device 103.

In one example, all of the water provided from the water heater 25 through water supply 25b passes through the bubble generation device 103 such that every device using hot water also receives bubbles 110. The water heater 25 (including tank 25a, water supply 25b, and optionally fuel supply 25c) may provide heated water to the other appliances. The water heater 25 may include a temperature setting that describes the target temperature for the water in the water heater. The water heater 25 may include a volume setting that defines an amount of water that is heated in the water heater 25. The water heater 25 may include a flow sensor configured to measure a flow of water in or out of the water heater 25, and the controller 100 may activate or deactivate the bubble generation device 103 based on the output of the flow sensor.

The water supply 25b may include a water filter to filter water before the water is provided to any of the other kitchen devices or to the bubble generation device 103. The water filter may include various settings including filtering modes that target particular contaminants. For example, the water filer may include a lead filtering mode which may target removing lead from the water, a bacteria filtering mode which may target removing bacteria from the water, or specific particulate filtering mode for removing a specific particulate from the water.

The water heater 25 may be a point of use water heater or tankless water heater that is configured to heat water on demand. The bubble generation device 103 is configured to treat the water heated by the water heater 25. In addition or in the alternative, the bubble generation device 103 may be placed upstream of the water heater 25 and be activated to clean the water heater 25. The MNBs may reduce the formation of limescale in the water heater 25. The MNBs may remove limescale from the water heater 25.

The refrigerator 24 may include a water dispenser 30. Alternatively, the water dispenser 30 may be a standalone device or another type of beverage dispenser. The bubble generation device 103 may be incorporated into the water dispenser 30. The bubble generation device 103 may treat the water or other beverage to improve hydration and oxygen levels in the liquid.

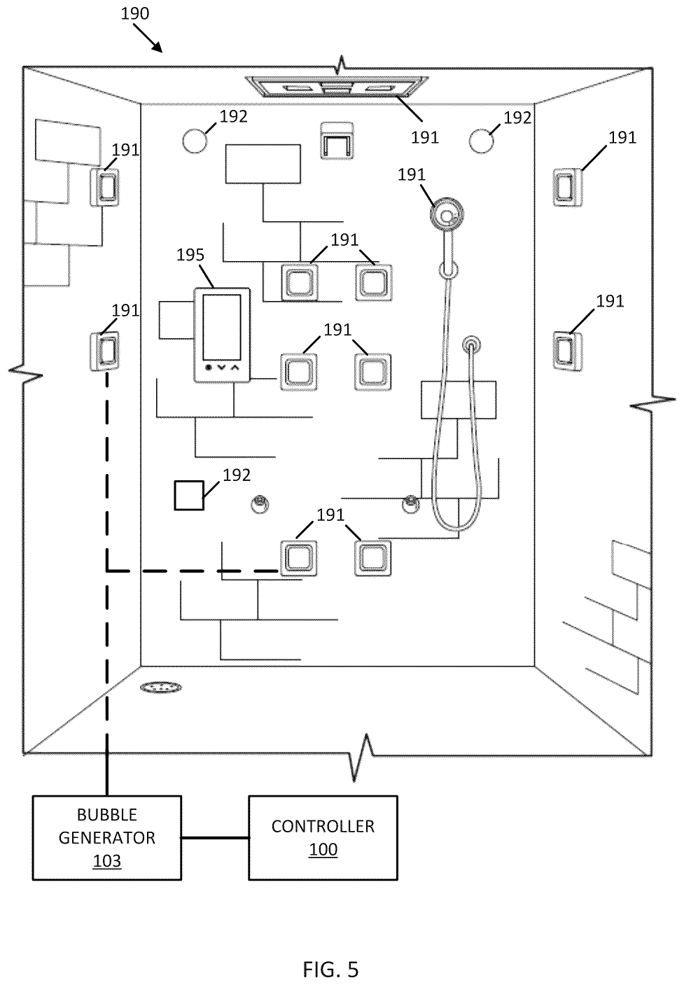

FIG. 5 illustrates example shower appliances for use with a bubble disinfection system. A shower 190 includes a shower enclosure and several shower subsystems (i.e., a water subsystem, an audio subsystem, a steam subsystem, a lighting subsystem, etc.). Each of the shower subsystems has output devices (e.g., shower outlets, flow control valves, temperature control valves, solenoids associated with the valves, lighting devices, audio output systems, steam outlets, etc.) configured to provide a user of the shower with an enhanced showering experience. The shower 190 may include multiple water dispensers 191, sensors 192, and at least one control panel 195. The control panel 195 includes an electronic display. The electronic display is configured to display graphical user interfaces for allowing user control of the various shower subsystems and/or shower output devices.

The bubble generation device 103 generates bubbles and provides water including the generated bubbles ot one or more of the water dispensers 191. The controller 100 may activate and deactivate the bubble generation device 103 based on operation of the shower 190, a predetermined time schedule, or feedback from one or more sensors 192. The sensor 192 may proximity sensors or motion sensors that determine when no user is present in the shower so that the bubble generation device 103 releases bubbles into the shower only when the shower is vacant. The sensor 192 may determine an air quality or water quality in the shower using a VOC sensor to detect organic chemicals and compounds so that the bubble generation device 103 releases bubbles into the shower only when VOCs reach a predetermined level.

In various embodiments, the controller 100 may be integrated with the control panel 195, physically separate from the control panel 195, or partially integrated and partially separate from the control panel 195. The control panel 195 may include a touch-sensitive panel overlaying the electronic display (e.g., a capacitive touch screen), manually-operable buttons (e.g., capacitive touch buttons), and/or other user input devices configured to receive user input and provide the user input to the controller 100. The control panel 195 (e.g., via the controller) controls the various components of the shower in response to the user inputs (e.g., signals or data representing the user inputs) received at the user input devices.

Shower 190 includes a water subsystem having various output devices (i.e., shower outlets) located within the shower enclosure. For example, shower 190 is shown to include multiple water dispensers 191 including a front showerhead, a left showerhead, a right showerhead, an upper body spray, a middle body spray, a lower body spray, side body sprays, a handshower, and a rainhead. In various embodiments, the water subsystem or set of output devices may include any number or combinations of output devices. For example, in an alternative exemplary embodiment, the water subsystem may include a central body spray (e.g., a vertical column of shower outlets) in place of upper body spray and middle body spray. In another exemplary embodiment, the left showerhead and right showerhead may be located on front wall. Shower outlets may be located on any of surfaces and may include additional or fewer shower outlets in various embodiments.

The water subsystem may include one or more analog or digital valves. Valves of the system may be configured to allow the controller to cause electronically controlled mixing bubbles generated by the bubble generation device 103 selectively to particular water dispensers 191. The user may select certain dispensers for the bubbles using the control panel 195. The distribution of bubbles to the water dispensers 191 may follow a predetermined pattern.

In some embodiments, a control panel 195 is configured to receive user inputs for controlling the shower subsystems and for communicating settings and status information of the shower subsystems to a user. Control panel 195 generally includes a housing and an electronic display (e.g., an LCD panel). The housing includes various attachment points (e.g., brackets, fasteners, portions for receiving screw heads, etc.) for mounting control panel 195 within shower enclosure. The housing also provides a waterproof casing to protect electronic display and associated internal electronic components from moisture. A touch-sensitive panel (e.g., a capacitive touch panel) may also be provided on the housing for receiving user inputs. A portion of the touch-sensitive panel may overlay electronic display to provide a touchscreen interface. The electronic display can be caused to display graphical user interfaces and to receive user inputs via the touch screen interface.

In one embodiment, the water dispenser 191 may include an electric shower. The electric shower heats water in the shower system 190 under commands from the control panel 195. The bubble generation device 103 may integrated in the electric shower. The bubble generation device 103 is configured to treat the water heated by the electric shower. In addition or in the alternative, the bubble generation device 103 may be placed upstream of the electric shower and be activated to clean the electric shower. The MNBs may reduce the formation of limescale in the electric shower. The MNBs may remove limescale from the electric shower.

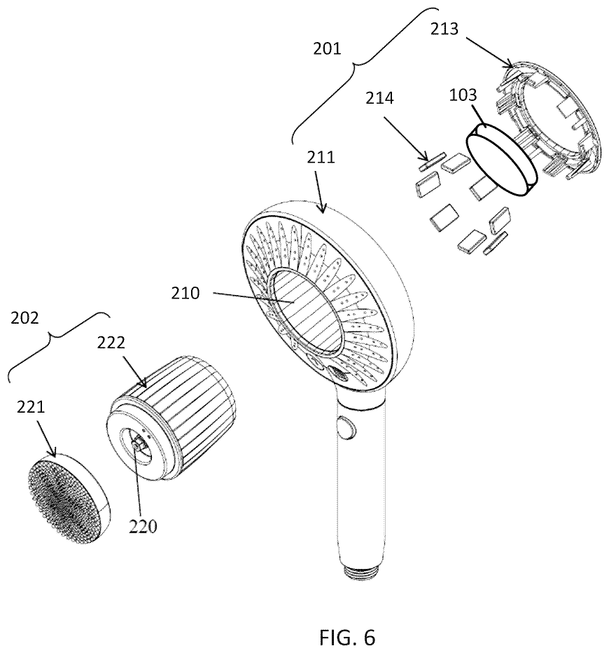

FIG. 6 illustrates a spray head 201 (e.g., for a water sprayer 191) including a bubble generation device 103. The following features may be applied to any of the example water sprayers 191. Water is provided from a water supply (e.g., line pressure water supply, hose, pipe, etc.) to the bubble generation device 103, which adds MNBs to the water that are sprayed or otherwise dispensed from the spray head 201. In various embodiments, the spray head 201 a includes a stream of water for deep cleaning. For example, in some embodiments, the spray head 201 may implement the bubble generation device 103 using a high-frequency vibration atomization unit configured to reduce water droplet size to approximately to one micron or less.

The spray head 201 may be removably coupled to a massage assembly 202 that is operable to move with respect to the spray head 201. The massage assembly 202 may include a massage brush head 221 and a driving mechanism 222. The driving mechanism 222 is configured to drive the massage brush head 223 to rotate with respect to the spray head 201. The massage assembly 202 may be inserted into opening 210 of the spay head 201 (e.g., snap-fitting, a threaded connection, a magnetic connection, etc.). In this way, the driving mechanism 222 may be inserted into the opening 210 or pulled out from the opening 210. The user can place the massage assembly 202 onto the spray head 201 when a massage operation is desired. After use, the user can remove the massage assembly 202 from the spray head 201.

The driving mechanism 222 may also vibrate (e.g., via a vibration motor, or a rotary vibration motor with both an integrated rotary function and vibration function). The vibration of the driving mechanism may cause bubbles to be generated by the spray head 201. In other examples, the bubble generation device 103 is included to cause MNBs to be generated within the spray head 201. The bubble generation device 103 may be secured to the spray head 201 by a cover 213 that attaches to spray head main body 211 (e.g., housing).

The massage assembly 202 may be magnetically coupled to the spray head 201. For example, the spray head 201 may include a first magnet 214 adjacent to or around the opening 210. A second magnet is mounted within the drive mechanism 222 to attract the first magnet 214.

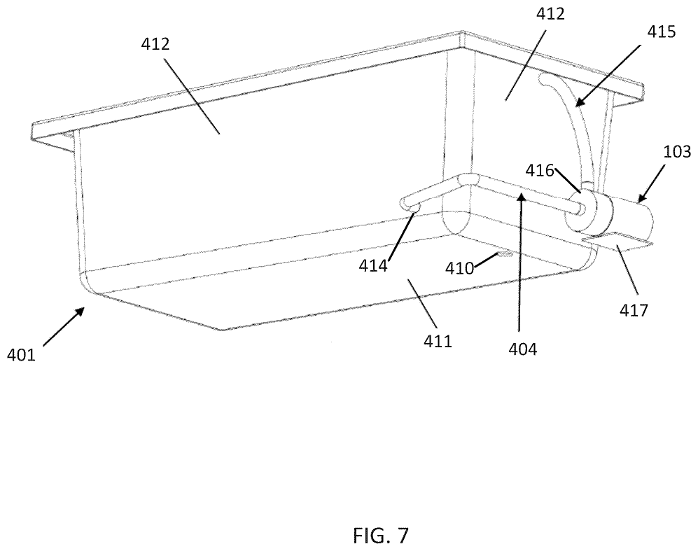

FIG. 7 illustrates an example bathtub 401 for use with a bubble generation device 103. The bathtub 401 includes a body 412 configured to hold water and a base 411 configured to support the body 412 and including a main drain 410. The body 412 may also include a side drain 414 that connects a supply pipe 404 to the bubble generation device 103. A pump 416 may recirculate water through the side drain 414 through the supply pipe 404 to the bubble generation device 103. The bubble generation device 103 may generate MNBs according to any of the embodiments herein and provide the MNBs to the recirculating water, which is returned to the bathtub 401 through delivery pipe 415. The bubble generation device 103 may be supported by a platform 417, which is coupled to the bathtub 401.

In another example, not pictured, the bubble generation device 103 may be provided to a main supply line of a bathtub. That is, the bubble generation device 103 may be coupled between a water line supply and the faucet of the bathtub 401.

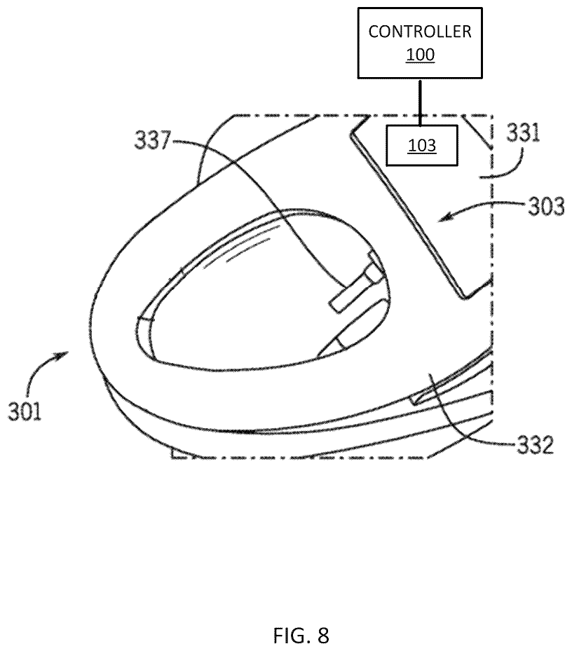

FIG. 8 illustrates an example bidet wand 337 for use with a bubble generation system 103. The bidet wand 337 may be integrated with a toilet 301 or a toilet seat assembly 332. The bubble generation system 103 may be located in a cavity 303 and may be accessible via a cover 331.

The bubble generation system 103 may generate MNBs into a reservoir tank that supplies the bidet wand 337 or a tubing that supplies the bidet wand 337. The MNBs may treat the water that is supplied through the bidet wand 337. In some examples, the MNBs may improve the hydration level of the skin that comes in contact with the water that is supplied through the bidet wand 337. The MNBs may treat the interior of the bidet want 337, reservoir, or tubing. For example, the MNBs may remove contaminants or reducing scaling in the bidet.

As described herein, a controller 100 may generate commands for the bubble generation system 103 to start generating MNBs, stop generating MNBs, and/or specifying a parameter of the MNBs. For example, the controller 100 may instruct the bubble generation system 103 to generate MNBs in response to a user command. The user command may be a button pressure to initiate dispensing of water through the wand 337. In other examples, the controller 100 may instruct the bubble generation system 103 to generate MNBs in response to detect of the user. For example, a sensor (e.g., pressure sensor, weight sensor) inside or otherwise associated with the seat assembly 332. When the user sits on the seat assembly 332, the presence of the user is reflected by the sensor data, causes the bubble generation system 103 to generate MNBs for subsequent dispensing by the wand 337. In some examples, the wand 337 is directed (e.g., pointed at) to the user for cleaning the user, and in some examples, the wand 337 is directed (e.g., pointed at) the toilet bowl for cleaning the toilet bowl.

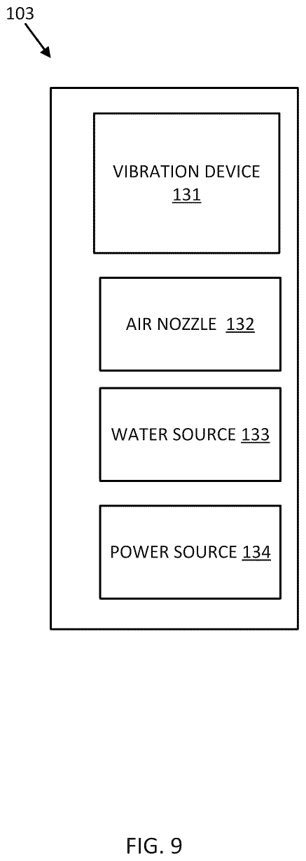

FIG. 9 illustrates an example bubble generation system including a vibration device 131, an air nozzle 132, a water source 133, and a power source 134. The power source 134 may include a battery or other power supply (e.g., AC to DC converter) that provides an electrical signal to drive the vibration device 131. The vibration device 131 provides a high frequency vibration to the air nozzle 132 and/or the water source 133. Air from the air nozzle 132 is provided to the water from the water source 133 to create MNBs under a shearing action from the high frequency vibration. Additional, different, or fewer components may be included.

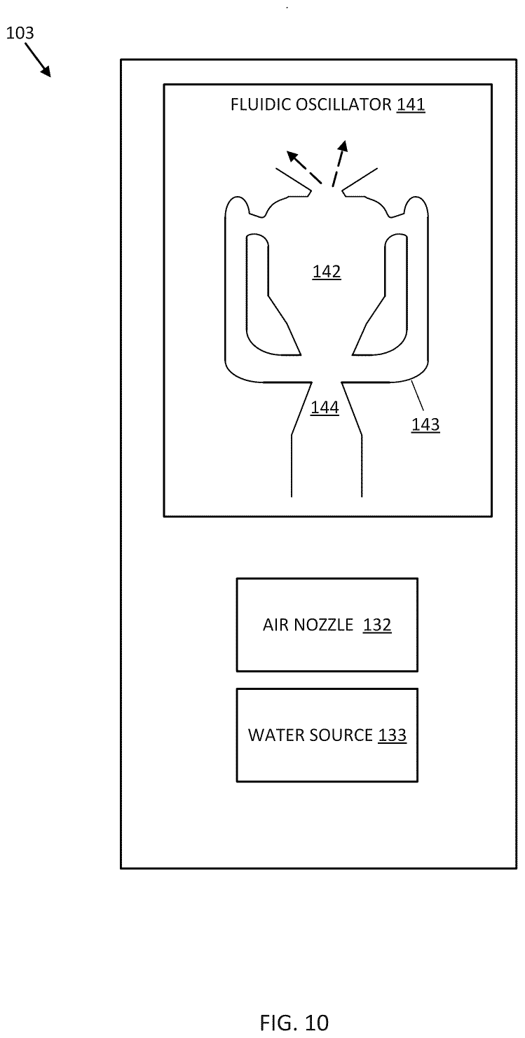

FIG. 10 illustrates another example bubble generation system including a fluidic oscillator 141, an air nozzle 132, and a water source 133. In this embodiment any electrical power source may be omitted. Instead, water from the water source 133 oscillates through one or more cavities 142, feedback loops 143, internal nozzles 144, and other structure within the fluidic oscillator 141 to create an oscillating force. The oscillating force is applied to the air at the junction of the water source and the air nozzle to create MNBs under a shearing action from the oscillating force. The size and/or shape of the one or more cavities 142, feedback loops 143, internal nozzles 144, and other structure within the fluidic oscillator 141 may be selected to define a parameter of the MNBs or the MNB generation process. The parameter may include the diameter of the MNBs or a statistical parameter of the distribution of the diameters of the MNBs. The parameter may include a ratio of microbubbles and nanobubbles. The parameter may include flow rate that defines the shearing action or oscillating force for generation of the MNBs. Additional, different, or fewer components may be included.

The fluidic oscillator 141 may include interconnected flow channels (e.g., passages, etc.) that include geometries which may be altered to selectively control the flow of water ejected from the fluidic oscillator 141. For example, the channels may be configured to provide pulsating or oscillating flows of water to achieve improved generation of MNBs, which, advantageously, improves the cleaning capabilities of the plumbing fixture. Alternatively, or in combination, the fluidic oscillator 141 may be configured to control the timing of the flow through the one or more jets. Multiple fluidic devices may be interconnected through flow channels as well.

The fluidic oscillator 141 may include one or more fluidic modules and embodiments herein include two, three, four, five, or any number of fluidic modules interconnected through fluid pathways or through overlapping feedback paths. An example fluidic oscillator may be interchangeably mounted to the toilet. Thus, the toilet may be interchangeably mounted with a range of quantities of fluidic modules (e.g., 2-10 fluidic modules) in a single fluidic oscillator 141. In addition, the toilet may be interchangeably mounted with a range of quantities of fluidic oscillator 141, each having one or more fluidic modules. A single fluidic oscillator 141 may constitute a fluidic device and thus the term fluidic device may be used to describe one fluidic oscillator in a device having multiple fluidic oscillators. The fluidic oscillator 141 may direct water to the toilet bowl.

The water source 133 may be a tube, a hose, or other fluid directing path. The water source 133 may connect the fluidic oscillator 141 to a water supply. The water source 133 may be the water line (e.g., utility, well) of the building.

The fluidic oscillator 141 may include a passive passage. The passive passage may include a diffuser, a feedback channel, an amplifier, or a diverter.

The fluid oscillator 141 may include a mixing cavity (e.g., cavity 142) in line or adjacent to the main flow channels and/or the feedback channels 143. The pressurized fluid to flow may create a spatially oscillating (fan sweep back and forth) for shearing off MNBs. No power source is required. However, the input fluid (e.g., water supply) is provided under pressure or under with potential energy from gravity. The diameter of the pipe may be selected to increase or decrease the input fluid to a desired pressure. The curved walls of the mixing cavity 142 provide a path for the flow of fluid to exhibit the coanda effect in which the flow attaches itself to the walls of the mixing cavity 142 and changes direction because it remains attached as the curved walls of the mixing cavity 142 curve away from the initial direction from the main flow channel.

The fluid oscillator 141 includes one or more geometric features at the outlet of the fluid oscillator 141 that cause a fan output water flow to oscillate across a predetermined angle range. The fluidic oscillator 141 is self-sustaining and self-inducing by virtue of the shape of the main flow channel, the feedback channels 143, and/or the mixing cavity 142.

In addition, one or more features of the outlet of the fluidic oscillator 141 applies a limiting condition (diffuser) on the fan output water flow to oscillate across the predetermined angle range. The limiting condition may be a geometric feature of the outlet of the fluidic device 141. In one example, the limiting condition is provided by a geometry including a narrow neck extended into the mixing cavity 142. The neck limits the predetermined angle range by blocking some of the flow of water that unimpeded would have escaped the mixing cavity 142 to the outlet of the fluidic oscillator 141. The narrow neck may also set a particular oscillation frequency due to reflection of the fluid back into the fluidic oscillator 141. The neck may be omitted to reveal a larger outlet of the fluidic device 141.

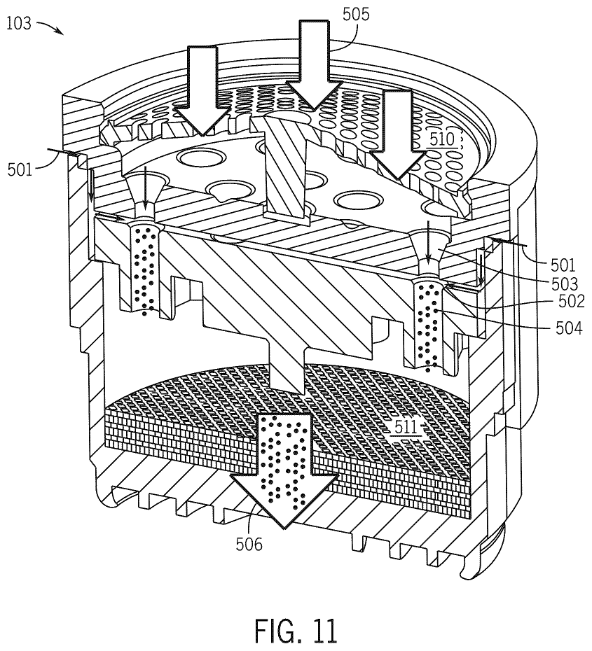

FIG. 11 illustrates an example bubble generation system 103 as applied to a shower head or other water dispensing device. The bubble generation system 103 in this example includes one or more venturi 502 that merges a flow of water and a flow of air. A flow of water 505 is provided to the bubble generation device 103. A first filter or screen 510 distributes the flow of water 505 substantially evenly across the bubble generation device 103. The flow of water is directed into multiple cones or conical passages 503, increasing the velocity of the water. As the high velocity water passes the venturi 502, air at opening 501 is drawn into the flow of water 505, creating MNBs 504. The flow of the water at the venturi 502 creates the shearing force for formation of the MNBs 504. The shearing force and the size of the MNBs 504 (e.g., the distribution of various sizes of bubbles) may be adjusted based on the shape of the conical passages 503, the quantity of the conical passages 503, and other features. Besides air, ozone, other gases, or other compounds may be provided at the opening 501. Additional, different, or fewer components may be included.

In one alternative, the bubble generation system 103 applied to the shower head may be electronically controlled. As described herein, a controller 100 may generate commands for the bubble generation system 103 to start generating MNBs, stop generating MNBs, and/or specifying a parameter of the MNBs. For example, the controller 100 may instruct the bubble generation system 103 to generate MNBs in response to a user command from a shower controller touch screen or other user input. In other examples, the controller 100 may instruct the bubble generation system 103 to generate MNBs in response to detect of the user. For example, a motion sensor, a gesture sensor, or a heat sensor may detect the presence of a user in the shower. The presence of the user is reflected by the sensor data, causes the bubble generation system 103 to generate MNBs for subsequent dispensing by the shower head.

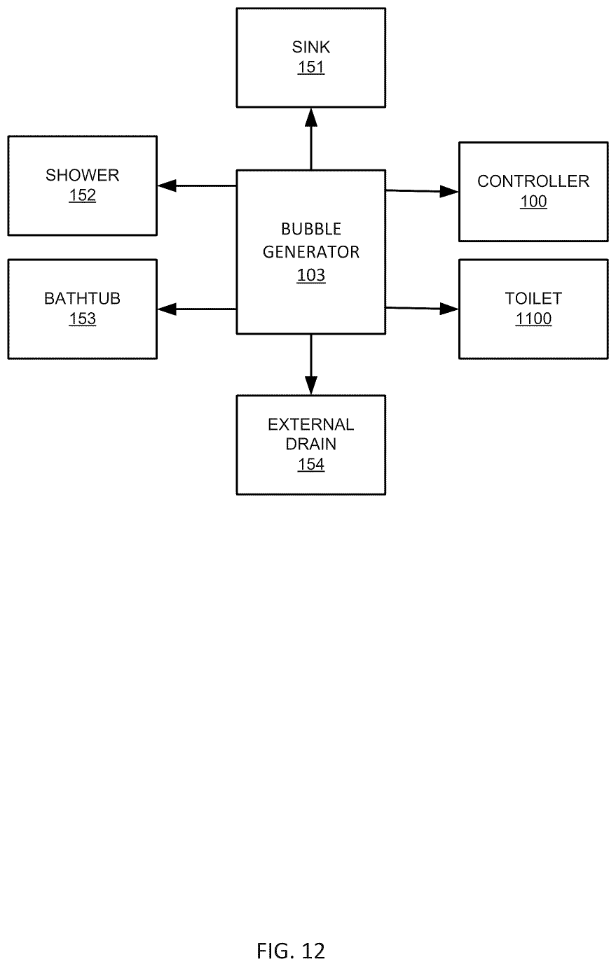

FIG. 12 illustrates a distribution system for the generated bubbles. The bubble generation device 103 may be coupled via a valving system and pipes or hoses to several appliances including a sink 151, a shower 152, a bathtub 153, a toilet 1100 and an external drain 154. The controller 100 provides commands to the bubble generation device 103 and/or valves to supply MNBs to the various appliances.

In one example, the controller 100 may receive data indicative of a presence of a user at a first appliance and a first time period and dispense MNBs at the first time period. Subsequently, the controller 100 may receive data indicative of a presence of a user at a second appliance at a first time period and dispense MNBs at the second time period.

For example, a user may be detected at toilet 1100. The controller 100 generates MNBs for use at the toilet 1100 and opens a valve between the bubble generator 103 and the toilet 1100. The MNBs are provided from the bubble generator 103 to the toilet 1100 for one or more purposes such as treatment of the water in the tank of the toilet, cleaning of the user, or cleaning of the toilet. The user moves from the toilet 1100 to the shower 152. The user is detected at the shower 152. The controller 100 generates MNBs for use at the shower 152 and opens a valve between the bubble generator 103 and the shower 152. The MNBs are provided from the bubble generator 103 to the shower 152.

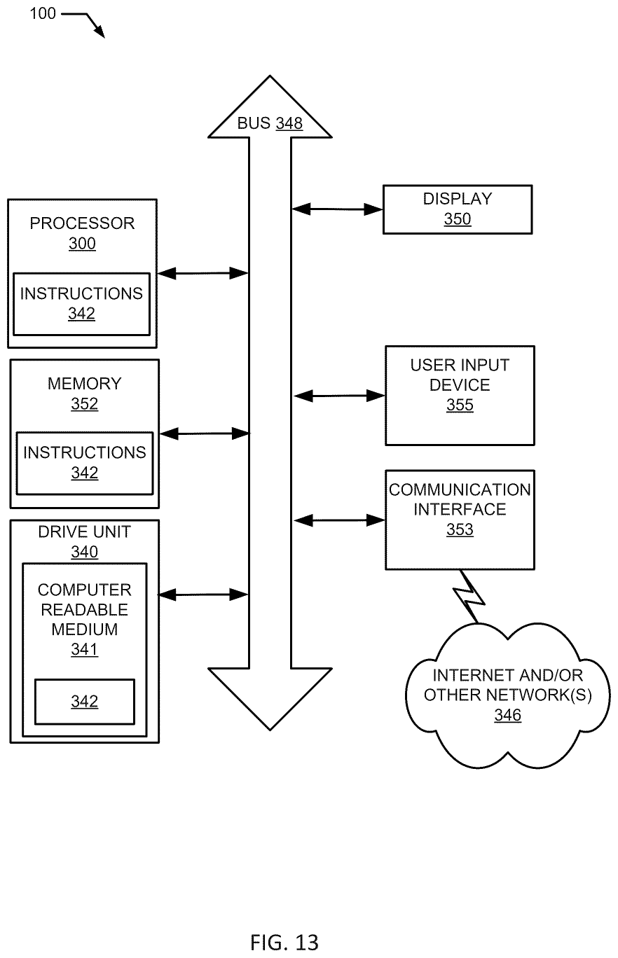

FIG. 13 illustrates an example controller or control system 100 for any off the bubble generation systems. The controller 100 may include a processor 300, a memory 352, and a communication interface 353 for interfacing with devices or to the internet and/or other networks 346. In addition to the communication interface 353, a sensor interface may be configured to receive data from the sensors described herein or data from any source for analyzing air or water properties or the operation of the appliances described herein. The components of the control system 400 may communicate using bus 348. The control system 100 may be connected to a workstation or another external device (e.g., control panel) and/or a database for receiving user inputs, system characteristics, and any of the values described herein.

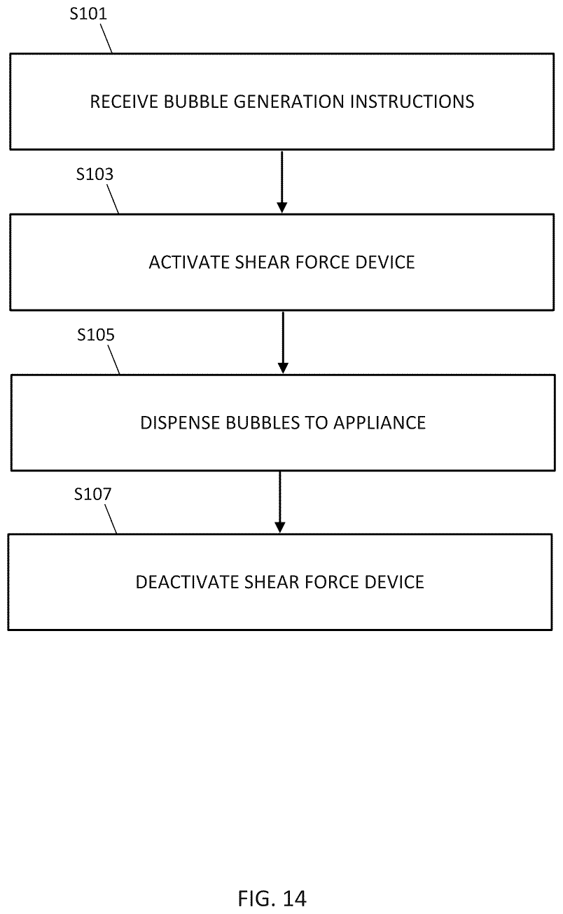

FIG. 14 illustrates an example flow chart for the controller of FIG. 13. Additional, different, or fewer acts may be included.

At act S101, bubble generation instructions are received at the controller 100. The instructions may be in response to sensor data or a user input. The bubble generation instructions may include a start time to begin generation of the MNBs, a stop time to end generation of the MNBs, and/or a parameter defining a shape or quantity of the MNBs.

At act S103, the controller 100 activates the shear force device. The controller may instruct the shear force device according to the start time. The shear force device applies a force to a flow of air to generate the MNBs according to the parameter defining the shape or quantity of MNBs.

At act S105, the controller 100 opens a valve to dispense the MNBs to the appliance. The valve may include a solenoid or a gate valve that is controlled electronically. In some examples, the valve is omitted and pipe flow through the dispensing system distributes the MNBs only in response to generation of the MNBs.

At act S107, the controller deactivates the shear force device. The controller may instruct the shear force device according to the stop time.

Optionally, the control system 100 may include an input device 355 and/or a sensing circuit in communication with any of the sensors. The sensing circuit receives sensor measurements from as described above. The input device 355 may include a switch (e.g., actuator), a touchscreen coupled to or integrated with, a keyboard, a remote, a microphone for voice inputs, a camera for gesture inputs, and/or another mechanism.

Optionally, the control system 100 may include a drive unit 340 for receiving and reading non-transitory computer media 341 having instructions 342. Additional, different, or fewer components may be included. The processor 300 is configured to perform instructions 342 stored in memory 352 for executing the algorithms described herein. A display 350 may be supported by any of the components described herein. The display 350 may be combined with the user input device 355.

Processor 300 may be a general purpose or specific purpose processor, an application specific integrated circuit (ASIC), one or more programmable logic controllers (PLCs), one or more field programmable gate arrays (FPGAs), a group of processing components, or other suitable processing components. Processor 300 is configured to execute computer code or instructions stored in memory 352 or received from other computer readable media (e.g., embedded flash memory, local hard disk storage, local ROM, network storage, a remote server, etc.). The processor 300 may be a single device or combinations of devices, such as associated with a network, distributed processing, or cloud computing.

Memory 352 may include one or more devices (e.g., memory units, memory devices, storage devices, etc.) for storing data and/or computer code for completing and/or facilitating the various processes described in the present disclosure. Memory 352 may include random access memory (RAM), read-only memory (ROM), hard drive storage, temporary storage, non-volatile memory, flash memory, optical memory, or any other suitable memory for storing software objects and/or computer instructions. Memory 352 may include database components, object code components, script components, or any other type of information structure for supporting the various activities and information structures described in the present disclosure. Memory 352 may be communicably connected to processor 300 via a processing circuit and may include computer code for executing (e.g., by processor 300) one or more processes described herein. For example, memory 298 may include graphics, web pages, HTML files, XML files, script code, shower configuration files, or other resources for use in generating graphical user interfaces for display and/or for use in interpreting user interface inputs to make command, control, or communication decisions.

In addition to ingress ports and egress ports, the communication interface 353 may include any operable connection. An operable connection may be one in which signals, physical communications, and/or logical communications may be sent and/or received. An operable connection may include a physical interface, an electrical interface, and/or a data interface. The communication interface 353 may be connected to a network. The network may include wired networks (e.g., Ethernet), wireless networks, or combinations thereof. The wireless network may be a cellular telephone network, an 802.11, 802.16, 802.20, or WiMax network, a Bluetooth pairing of devices, or a Bluetooth mesh network. Further, the network may be a public network, such as the Internet, a private network, such as an intranet, or combinations thereof, and may utilize a variety of networking protocols now available or later developed including, but not limited to TCP/IP based networking protocols.

While the computer-readable medium (e.g., memory 352) is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored. The computer-readable medium may be non-transitory, which includes all tangible computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

Herein, the phrase “coupled with” or “coupled to” is defined to mean directly connected to or indirectly connected through one or more intermediate components. Such intermediate components may include both hardware and software based components. Further, to clarify the use in the pending claims and to hereby provide notice to the public, the phrases “at least one of <A>, <B>, . . . and <N>” or “at least one of <A>, <B>, . . . <N>, or combinations thereof” are defined by the Applicant in the broadest sense, superseding any other implied definitions here before or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed. Furthermore, to the extent that the term “or” is employed (e.g., <A> or <B>) it is intended to mean “<A> or <B> or both.” When the intent is to indicate “only A or B but not both” then the term “only A or B but not both” will be employed.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

What is claimed is:

1. A toilet comprising:
a tank;
a bowl;
a bubble generation device including a nozzle; and
a controller configured to generate a command for the bubble generation device to release nanobubbles from the nozzle into the tank and/or the bowl.

2. The toilet of claim 1, wherein the nanobubbles include a majority of bubbles having a diameter of less than 1 micrometer.

3. The toilet of claim 1, wherein the bubble generation device releases a mixture of microbubbles and nanobubbles.

4. The toilet of claim 3, wherein the nanobubbles comprise a statistically significant portion of the mixture of microbubbles and nanobubbles.

5. The toilet of claim 1, wherein a lifetime duration of the nanobubbles is at least one minute.

6. The toilet of claim 1, wherein the command for the bubble generation device includes a start time.

7. The toilet of claim 1, wherein the command for the bubble generation device includes a stop time.

8. The toilet of claim 1, wherein the command for the bubble generation device includes a parameter of a bubble generation process.

9. The toilet of claim 8, wherein the parameter of the bubble generation process is a shear force to produce the nanobubbles.

10. The toilet of claim 1, wherein the command for the bubble generation device includes a size range for the nanobubbles.

11. The toilet of claim 1, further comprising:
a sensor configured to generate sensor data for detection a user of the toilet, wherein the command for the bubble generation device is sent in response to the sensor data.

12. The toilet of claim 1, further comprising:
a bidet wand, wherein the bubble generation device is configured to release nanobubbles from the nozzle into the bidet wand.

13. A sink comprising:
a basin;
a faucet;
a bubble generation device including a nozzle; and
a controller configured to generate a command for the bubble generation device to release microbubbles and/or nanobubbles from the nozzle into the basin or the faucet.

14. The sink of claim 13, wherein the command for the bubble generation device includes a stop time.

15. The sink of claim 13, wherein the command for the bubble generation device includes a parameter of a bubble generation process.

16. A water treatment apparatus comprising:
a user input device for a water consuming appliance;
a bubble nozzle; and
a gas source coupled to the bubble nozzle and activated in response to the user input device to induce cavitation and generate nanobubbles.

17. The water treatment apparatus of claim 16, further comprising:
a water tank configured to support at least the bubble nozzle and a quantity of water including the nanobubbles.

18. The water treatment apparatus of claim 17, wherein the water tank is coupled to a toilet and the user input device triggers a flush cycle of the toilet.

19. The water treatment apparatus of claim 17, wherein the water tank is coupled to a faucet and the user input device triggers water dispensing from the faucet.

20. The water treatment apparatus of claim 17, wherein the water tank is coupled to a showerhead and the user input triggers water to dispense from the showerhead.
